(19) United States
(12) Patent Application Publication
(10) Pub. No.: US 2021/0229247 A1
(43) Pub. Date: Jul. 29, 2021

(54) DRIVER SYSTEM AND METHOD

(71) Applicant: John Martin Petriccione II, Aston, PA (US)

(72) Inventor: John Martin Petriccione II, Aston, PA (US)

(21) Appl. No.: 17/157,582

(22) Filed: Jan. 25, 2021

Related U.S. Application Data
(60) Provisional application No. 62/967,014, filed on Jan. 28, 2020.

(51) Int. Cl. B25B 21/00; B25B 23/10

(52) U.S. Cl. CPC B25B 21/007; B25B 23/105

(57) ABSTRACT

The present invention relates to a driver system and method for engaging an article. During operational use of the driver system the user starts with the alignment of a bit and a cavity of the article, the bit is rotated to move a wedge into an internal wedge slot within the cavity of the article. This engagement of the wedge and the internal wedge slot locks the lateral movement of the bit relative to the article, therein allowing for the bit to stay engaged within the article during rotational or torsional force induced upon the article by the user of the bit.

### RELATED APPLICATION

This application claims priority to provisional patent application U.S. Ser. No. 62/967,014 filed on Jan. 28, 2020, the entire contents of which is herein incorporated by reference.

### BACKGROUND

### 1. Field of the Invention

The present invention relates to a driver system and method for improved ease of use.

### 2. Description of Related Art

In almost every commercial industry different fastener types and methods are used to adjoin one article to another. It is commonly understood that when choosing a fastener to use for fixing articles together, the necessary properties of the materials composing the fasteners must be taken into consideration. The permanence of a fixture along with the stability of the fixture must also factor into the user's fastener choice. The tensile strength and shear strength of the article will factor into determining the proper application as well. Many fasteners are made of steel, brass, and nickel along with other metals, such as aluminum or copper depending on their use. Many screws use coatings as well to prevent corrosion and cracking. Deck screws, for example, are coated and made of softer metal with a larger surface area to can maximize their load-bearing potential.

Issues arise when the user imparts a force on the article or fastener in an undesired direction, therein causing the material of the article or fastener to bend, deform, or even break. This also occurs during improper alignment of a corresponding bit and fastener. For example, when a smaller Philips shaped bit is used with a larger Philips shaped fastener, often the user may strip the fastener and/or the bit. This may also cause the coasting discussed above to be disfigured or damaged altering the desired function or lifespan of the fastener.

Further issues occur when trying to impart torsional force on an article or fastener within tight quarters or spaces with various hand tools. Commonly, a hand tool of the user does not fit within the workspace that the article or fastener needs to go. This results in lost fasteners, fasteners not properly installed, damaged fasteners, or injury to the user. A better solution is needed for keeping the article or fastener in contact with the bit of a tool during use.

### SUMMARY

The present invention relates to an improved driver system and method for engaging an article. During operational use of the driver system the user starts with the alignment of a bit and a cavity of the article, the bit is rotated to move a wedge into an internal wedge slot within the cavity of the article. This engagement of the wedge and the internal wedge slot locks the lateral movement of the bit relative to the article, therein allowing for the bit to stay engaged within the article during rotational or torsional force induced upon the article by the user of the bit.

Another objective of the present invention is to allow for pre-engagement of the article to the bit by rotating the article upon the bit before inserting the article into the desired location. For example, in an exemplary embodiment wherein the article is a screw, the screw is not able to fall off the bit before reaching the desired location the user desires to place the screw.

To do so, a driver system is presented for the secured fastening of an article. The driver system including a cavity protruding into the article and at least one locking slot positioned within the cavity. Next, at least one internal wedge slot within each of the at least one locking slot protrude into the article. A bit of the driver system is presented having a proximal end, a distal end, and at least one locking protrusion adjoined to the distal end. The distal end of the bit is shaped to substantially match the shape of the at least one locking slot within the cavity of the article. Locking slots within the cavity of the article aide are added for symmetry, stability, and greater purchase on the article. The user aligns the distal end of the bit to the at least one locking slot to properly insert the bit within the cavity of the article. Adjoined to the at least one locking protrusion, at least one wedge extends outward from and is adjoined to each of the at least one locking protrusion. During a first mode of operation, the bit is inserted into the cavity and rotated to lock the at least one wedge into the internal wedge slot. The result limits lateral movement of the bit relative to the article during rotation of the article.

### BRIEF DESCRIPTION OF THE FIGURES

The detailed description of some embodiments of the invention is made below with reference to the accompanying figures, wherein like numerals represent corresponding parts of the figures.

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 shows an exemplary isometric view of one embodiment of the bit of the driver system.

FIG. 2 shows an exemplary isometric view of one embodiment of the driver system.

FIG. 3 shows an exemplary isometric view of one embodiment of the bit of the driver system.

FIG. 4A shows an exemplary isometric view of one embodiment of the article of the driver system.

FIG. 4B shows an exemplary front view of one embodiment of the article of the driver system.

FIG. 5A shows an exemplary top view of one embodiment of the bit of the driver system.

FIG. 5B shows an exemplary top view of one embodiment of the article of the driver system.

FIG. 5C shows an exemplary bottom view of one embodiment of the bit of the driver system.

FIG. 6A shows an exemplary cross-sectional view of one embodiment of the article of the driver system taken along parting line 4-4 of FIG. 4B.

FIG. 6B shows an exemplary isometric view of one embodiment of the article of the driver system.

FIG. 7 shows an exemplary isometric view of one embodiment of the driver system.

FIG. 8A shows an exemplary top view of one embodiment of the driver system in POS.1A.

FIG. 8B shows an exemplary top view of one embodiment of the driver system in POS.1B.

FIG. 9A shows an exemplary front view of one embodiment of the article of the driver system.

FIG. 9B shows an exemplary isometric view of one embodiment of the article of the driver system.

FIG. 9C shows an exemplary cross-sectional view of one embodiment of the article of the driver system taken along parting line 9-9 of FIG. 9A.

FIG. 9D shows an exemplary isometric view of one embodiment of the article of the driver system.

### DETAILED DESCRIPTION OF CERTAIN EMBODIMENTS

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure.

The present invention relates to a driver system 100 having a bit 105 and an article 110 acted upon by the bit 105. In the present embodiment, the bit 105 has a proximal end 106 and a distal end 107. The distal end 107 of the bit 105 comprises at least one locking protrusion 115 and the proximal end 106 of the bit 105 comprising a shaft 130 for engagement with various hand tools 140 or other power tools commonly used by one skilled in the art. The hand tool 140 may also comprise, by way of non-limiting example, manually engaged tools such as wrenches, ratchets, screwdrivers, socket drivers, and other hand tools.

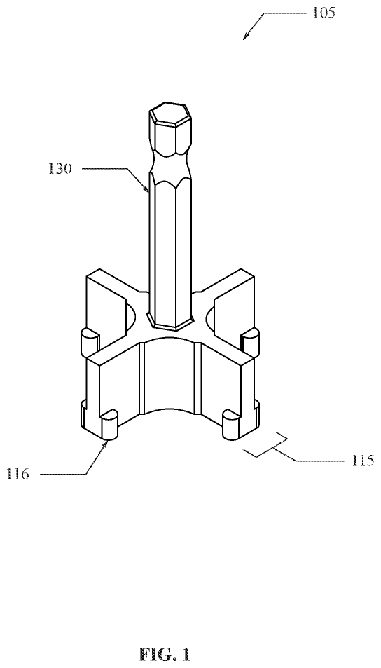

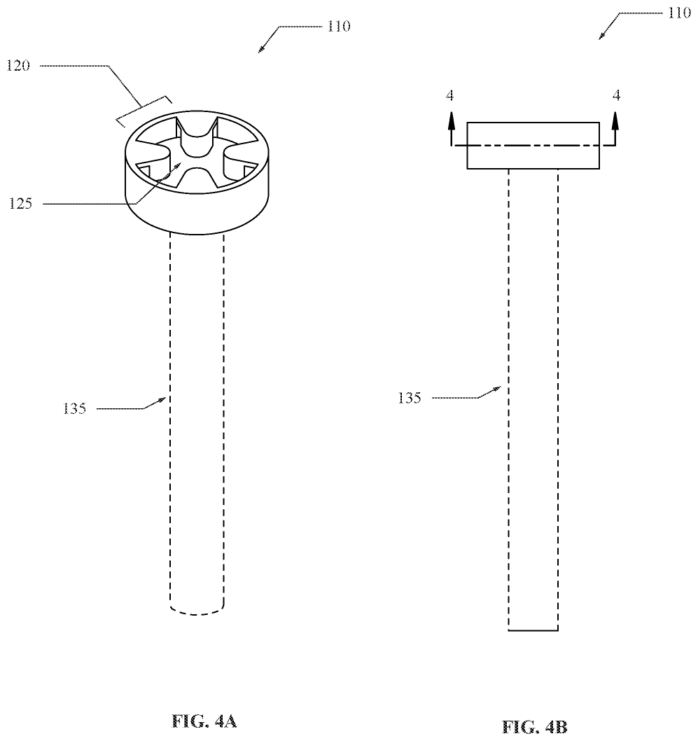

As shown in FIG. 1, the current exemplary embodiment of the locking protrusion 115 further comprises at least one wedge 116 on opposing sides of the locking protrusion 115. As shown in FIGS. 4,4A and 4B an exemplary embodiment of a cavity 125 is shown within the article 110 a quantity of four total locking slots 120. In other embodiments, the cavity 125 may have at least one locking slot 120. For exemplary illustration, the article 110 shown in FIGS. 4A and 4B is a fastener 135, without limitation, the present invention may be applied to other articles such as caps, pipes, doors, lids, drains, containers, and other articles that are known to one skilled in the art that are rotatably and/or threadedly engaged. The cavity 125 shown in FIGS. 4A and 4B has a quantity of four total locking slots 120 to substantially match the quantity and size of the locking protrusions 115 of the bit 105. Within each of the locking slots 120 at least one internal wedge slot 122 may protrude outward from the at least one locking slot 120 within the cavity 125 into the article 110. The at least one internal wedge slot 122 is sized and shaped to substantially match the at least one wedge 116 of the bit 105. In some embodiments, the wedge 116 of the bit 105 may be tapered, textured, or staggered to aid in the engagement of the wedge 116 within the internal wedge slot of the cavity 125.

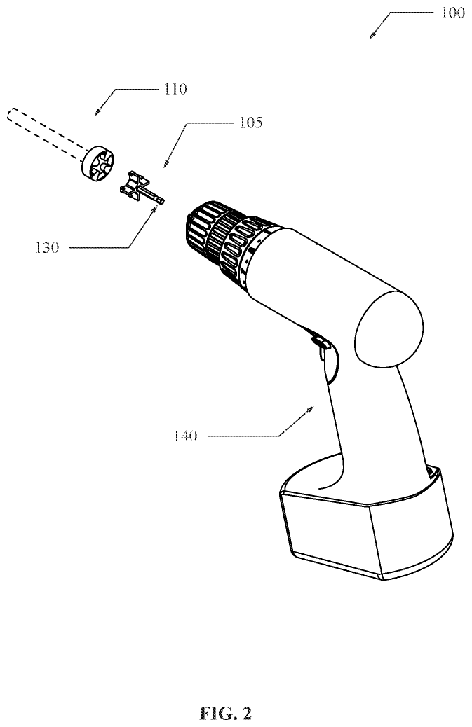

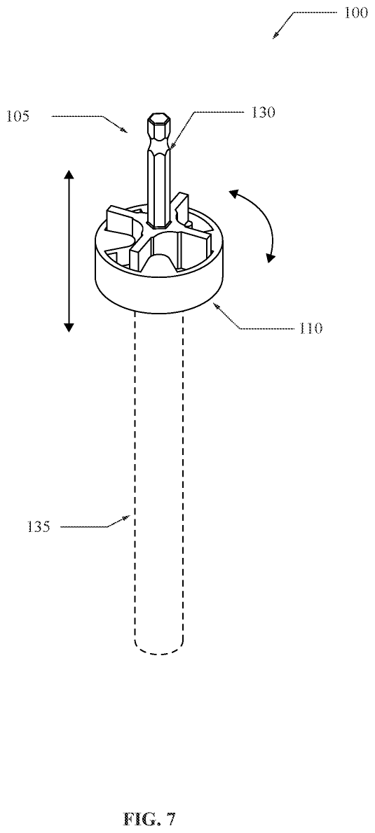

As shown in FIG. 2 and FIG. 7, during exemplary operation the driver system 100 is engaged by first adjoining the shaft 130 of the bit 105 to the hand tool 140 and aligning the at least one locking protrusions 115 to the locking slots 120 of the cavity 125. The user then subsequentially inserts the bit 105 into the cavity 125 of the article 110. Next, either clockwise or counter-clockwise engagement of the bit allows the at least one wedge 116 to enter within the protrusions of the at least one internal wedge slot 122 within the at least one locking slot 120. Therein this operation allowing the user to rotatably drive the article 110, in this exemplary embodiment the article 110 being a fastener 135. A primary improvement and function of the driver system 100 allows to user freedom to manipulate the hand tool intentionally or unintentionally without bit 105 leaving or moving within the cavity 125.

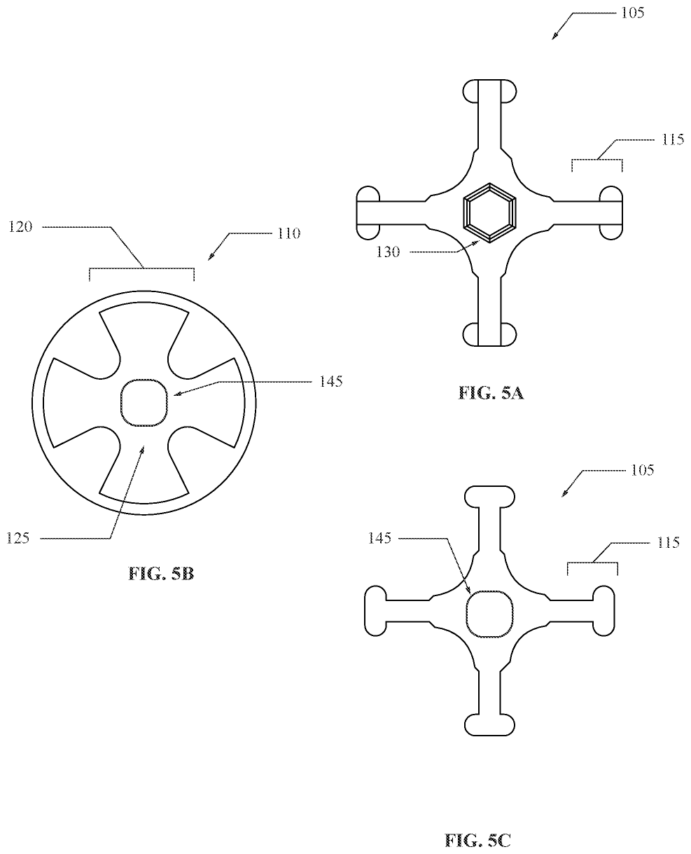

As further illustrated in FIGS. 5A, 5B, and 5C the bit 105 and/or the article 110 may further comprise at least one member of an attachment set consisting of: a magnet, a clip, a slide-fit, a clamp, a spring, an elastic member, an adhesive and other temporary alignment or attachment methods known to those skilled in the art. For example, the distal end 107 of the bit 105 may have a magnet polarized to attract to the material type of the article 110 or a corresponding magnet within the cavity 125 of the article 110. In other embodiments, the bit 105 and/or the article 110 may be comprised of at least one material of a material set consisting of: a ceramic material, a metal material, a wood material, a plastic material, a fiberglass material, a cast iron material, a carbon fiber material, an acrylic material, a composite material, a thermoset plastic, a thermoplastic, a glass material, and a nylon material.

Further exemplary operations are illustrated in FIGS. 7,8A and 8B, once the bit 105 is rotated enough for the wedge 116 to enter the internal wedge slot 122 the driver system 100 is in a locked position POS.1A, the user can not remove or pull out the bit 105 from the cavity 125 in locked POS.1A. When the article 110 is consequentially moved to a desired location of the user, the user may then rotate the at least one locking protrusion 115 of the bit 105 to align with the at least one locking slots 120. This additionally removes the wedge 116 from the internal wedge slot 122 and the driver system is put into an unlocked position POS.1B, therein allowing for removal of the bit 105 from the cavity 125.

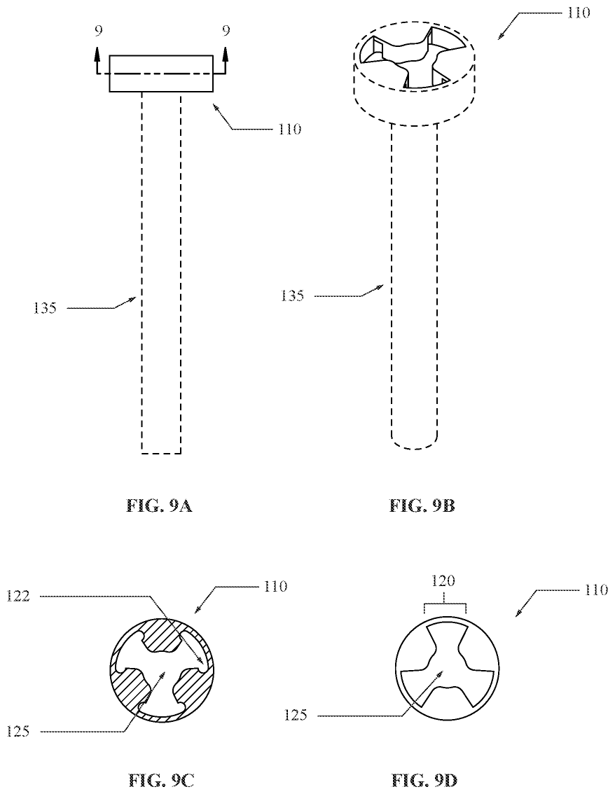

As shown in FIGS. 9A, 9B, 9C, and 9D the driver system 100 may comprise a cavity 125 having a quantity of three locking slots 120 and a quantity of three locking protrusions 115. Additionally, the article 110 is in no way limited to only a fastener 135. Other embodiments of the driver system 100 include the cavity 125 protruding into other articles such as, without limitation, lids of consumer products or common pipe fittings. In other embodiments, the shaft of the bit 105 is interchangeable and can be manipulated to meet the requirements of the user's hand tool 140. In other embodiments, the shaft 130 of the bit 105 is flexible and non-rigid allowing the user to access the articles 110 at varying degrees of access to the cavity 125.

In some embodiments, the article 110 and/or the cavity 125 of the article 110 of the driver system 100 comprise commonly known fasteners such as, by way of non-limiting example, permanent fasteners, non-permanent fasteners, bio-degradable fasteners, hex-head bolts, double-end bolts, eye bolts, carriage bolts, Penta bolts, socket head bolts, countersunk screws, deck screws, lag screws, machine screws, self-drilling screws, sheet-metal screws, wood screws, threaded rod sections, helical threaded inserts, pipe caps, drill bits, step drill bits, spade drill bits, auger bits, mixing bits, Forstner drill bits, coring drill bits, honing drill bits, tile drill bits, masonry drill bits, drill bit holders, drill bit extensions, countersink drill bits, hole saw components, key-ways, set screws, and other articles known to threadedly or rotatably engage to those skilled in the art.

In some embodiments, the proximal end 106 or the shaft 130 of the bit 105 of the driver system 100 comprises a hex shank, ¼″ hex shank, or the like to engage with keyed, keyless, or various drive chucks of hand tools 140. In other embodiments, the article 110, the distal end 107 of the bit 105 or the cavity 125 of the article 110 of the driver system 100 may comprise shapes to engage various commonly available bit shapes such as pozidrive bits, slotted bits, Torx bits, Phillips bits, tamperproof bits, internal hex bits, square recessed bits, nut setters, drywall bits, torq bits, tri-wing bits, spanner bits, tri-lobular bits and the like.

Exemplary materials for the composition of the bit 105, the article 110 and/or the cavity 125 include, by way of non-limiting example, the following materials: a 1045 induction hardened chrome-plated steel, a 1050 induction hardened chrome-plated steel, a 1045 hot rolled steel, a 1050 hot rolled steel, a 1045 micro-alloy steel, a 1050 micro-alloy steel, a 303 stainless steel, a 304 stainless steel, a 316 stainless steel, a 430FR stainless steel, a 17-4PH stainless steel, a ST52.3 or low carbon manganese steel, a 1020 steel, a 1018 steel, a 1144 steel, a 1045 steel, a 1137 steel, a 1141 steel, a 1214 steel, a 1215 steel, a 4130 steel, a 4140 steel, a 8620 steel, a 52100 steel, a 4142 steel and a 1026 steel. The driver system 100 and more specifically the article and/or bit 105 may be constructed by at least one of the following processes, by way of non-limiting example, including: a 3D printing process, sintering, casting, an injection moldings process, a CNC milling process, a rotational mold forming process, a blow molding process, a compression molding process and a vacuum forming process.

In some embodiments, the article 110 and/or the bit 105 may require external texture to grip the hand of the user. In exemplary embodiments, the external texture further comprises at least one member of a texture set consisting of: indentations, sandpaper, extrusions, knurling, a rough surface, bumps or any combination thereof.

In other embodiments, a further aide may be needed by the user to correlate the alignment and matching of the article 110 to the bit 105. In such embodiments, the driver system 100 may comprise at least one member of an identification set consisting of: an alphanumeric identification, a human user's name, a symbolic shape, a company brand, a numeric identification number, a QR code, a barcode, and an RFID tag. For example, the bit 105 may list or display a numerical digit to identify the correct size of the cavity 125 of the article 110.

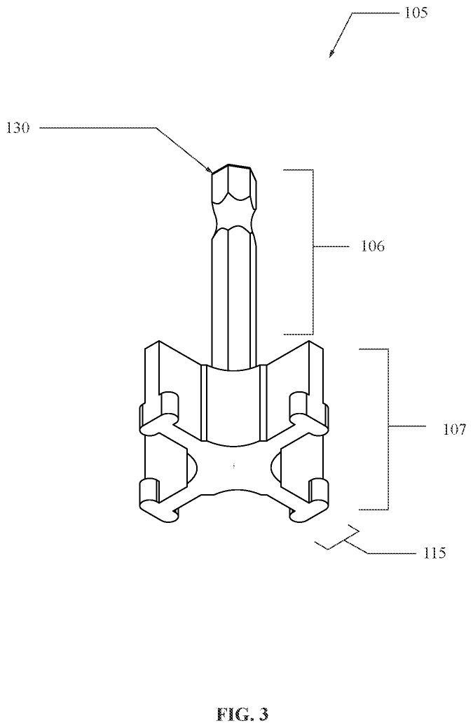

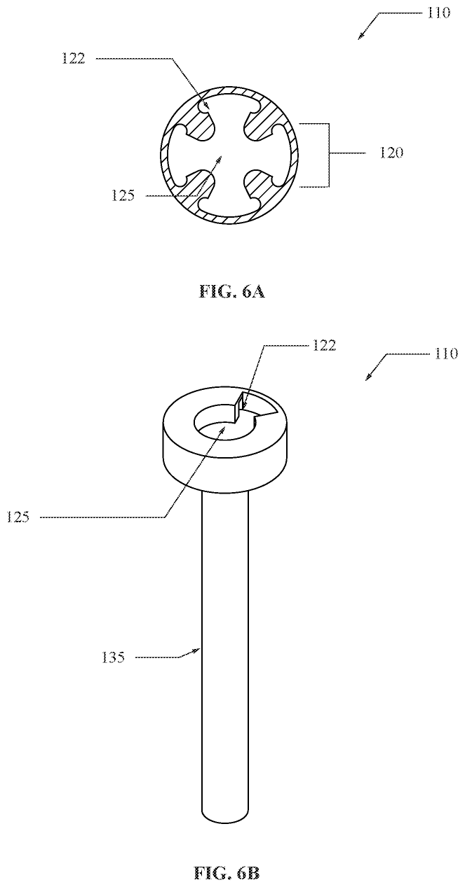

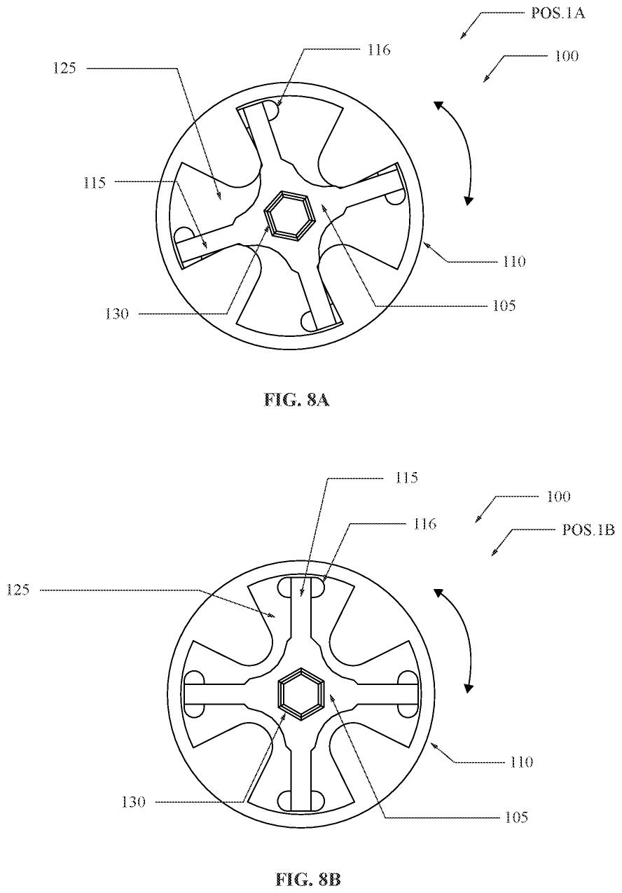

In reference to FIGS. 1 through 9, the present invention may include the following elements:
a driver system 100
a bit 105
a proximal end 106
a distal end 107
an article 110
a locking protrusion 115
a wedge 116
a locking slot 120
an internal wedge slot 122
a cavity 125
a shaft 130
a fastener 135
a hand tool 140
an attachment member 145

As used in this application, the term “a” or “an” means “at least one” or “one or more.”

As used in this application, the term “about” or “approximately” refers to a range of values within plus or minus 10% of the specified number.

As used in this application, the term “substantially” means that the actual value is within about 10% of the actual desired value, particularly within about 5% of the actual desired value and especially within about 1% of the actual desired value of any variable, element or limit set forth herein.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

Unless otherwise defined, all technical terms used herein have the same meaning as commonly understood by one of ordinary skill in the art to which this disclosure belongs.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

Any element in a claim that does not explicitly state “means for” performing a specified function, or “step for” performing a specified function, is not to be interpreted as a “means” or “step” clause as specified in 35 U.S.C. § 112, ¶ 6. In particular, any use of “step of” in the claims is not intended to invoke the provision of 35 U.S.C. § 112, å 6.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A driver system, for secured fastening of an article, the driver system comprising:
a cavity protruding into the article;
at least one locking slot positioned within the cavity,
at least one internal wedge slot within the at least one locking slot,
a bit having a proximal end and a distal end;
at least one locking protrusion adjoined to the distal end of the bit and shaped to substantially match a shape of the at least one locking slot;
at least one wedge adjoined to the at least one locking protrusion; and
wherein a first mode of operation the bit inserted the cavity and rotated to lock the at least one wedge into the at least one internal wedge slot.

2. The driver system of claim 1, wherein the at least one wedge further comprises a tapered shape, a texture or a staggered surface.

3. The driver system of claim 1, wherein the article is a fastener.

4. The driver system of claim 1, wherein the article is a drill bit extension wherein a commonly available bit is adjoined to the drill bit extension.

5. The driver system of claim 1, wherein the cavity of the article and/or the distal end of the bit further comprise at least one member of an attachment set.

6. The driver system of claim 1, wherein the article and/or the bit comprise an external texture to grip a hand of a user.

7. The driver system of claim 6, wherein the external texture further comprises at least one member of a texture set consisting of: indentations, sandpaper, extrusions, knurling, a rough surface, bumps or any combination thereof.

8. The driver system of claim 1, wherein the cavity and/or the distal end of the bit comprise of a shape of a commonly available bit.

9. The driver system of claim 1, wherein the proximal end of the bit comprises a hex shaft.

10. The driver system of claim 1, wherein the proximal end of the bit is flexible and non-rigid.

11. A method of adjoining an article to a bit comprising:
aligning a locking protrusion of the bit to a locking slot of a cavity of the article;
inserting the bit within the cavity of the article;
rotating the locking protrusion within the locking slot;
driving the article clockwise or counterclockwise;
re-aligning the locking protrusion and the locking slot; and
removing the bit from the cavity of the article.

12. The method of claim 11, further comprising:
inserting a wedge adjoined to the locking protrusion into an internal wedge slot within the locking slot of the cavity.
